(19) United States
(12) Patent Application Publication
(10) Pub. No.: US 2003/0097399 A1
(43) Pub. Date: May 22, 2003

(54) Workflow system for transferring a specific classified file

(76) Inventors: Tzu Chiang Yuan, San Francisco, CA (US); Edmar Magbanua Soriano, Newark, CA (US)

Correspondence Address: GARY CARY WARE & FREIDENRICH LLP, 1755 EMBARCADERO ROAD, PALO ALTO, CA, 94303-3340, US

(21) Appl. No.: 09/989,776

(22) Filed: Nov. 19, 2001

(51) Int. Cl. G06F 15/16

(52) U.S. Cl. 709/203

(57) ABSTRACT

A tailored classified file deposit screen is provided by a server connected to a first computer network. The tailored classified file deposit screen is configured to transfer a specific classified file based on a step in a sequence of steps of a process. A display of a specification of the file is provided. A means to identify the file on a storage device connected to a second computer network is also provided. Finally a means to transfer the file and a classification identifier to the server is provided.

### TECHNICAL FIELD

The present invention relates to a workflow system, and more particularly to a workflow system which transfers a specific classified file.

### BACKGROUND OF THE INVENTION

Many business activities can be described as a sequence of process steps where each process step has an input, a process that uses the input to create an output, and the output. The output of a process step can then be the input of a subsequent process step. Software systems, called workflow systems, have been developed to control the sequencing of process steps to control the flow of information and the access to the information. In general, each node in a workflow corresponds to a step in the process. A typical step in a process, a node in the workflow, displays data in a screen and the screen provides fields to enter data into the screen in response to the displayed data. Travel expense approval, purchasing of catalog items, and other processes can be envisioned as screens with structured fields that display the travel date, airline ticket expense, etc. or the catalog item, price, and delivery date.

In general, processes are not linear in that decisions must be made to direct the processes to reflect an external condition. Thus, some screens request a decision: an approval or rejection decision based on an external condition. These are called conditional branch operations. Consider an example workflow for travel expense approval, where an employee uses a screen with a travel expense form with fields for name, reason for the travel, travel dates, cost of plane ticket, hotel, etc. The employee enters data in the fields and submits the screen to the workflow system. The workflow system sends the screen to the employee's manager who examines the information and can “approve” or “reject” the travel expense. If “approved”, the workflow system sends the data to accounts payable where the data are used to pay a travel reimbursement. If “rejected”, the workflow system sends the data back to the employee. In addition, advanced workflow systems support processes that split into two parallel independent process flows. This operation is called a “fork”. An example of a fork in a travel expense process would be if the travel expense had to be approved by the employee's manager and by a travel manager where the workflow systems sends the travel expense screen to both at the same time so that each can make their approve/reject decision in parallel, that is, independent of each others decision. The conjoining of two parallel independent process flows is called a “join”. In the parallel expense example, the two approve/reject decisions leads to a common payment process and both decisions must be “approve” before proceeding to payment. Workflow systems have demonstrated to be effective in controlling processes where the data can be represented as fields in screens. See for example U.S. Pat. No. 6,170,002 and 5,978,836.

### SUMMARY OF THE INVENTION

In the present invention, a tailored classified file deposit screen is provided by a server connected to a first computer network. The tailored classified file deposit screen is configured to transfer a specific classified file based on a step in a sequence of steps of a process. A display of a specification of the file is provided. A means to identify the file on a storage device connected to a second computer network is also provided. Finally a means to transfer the file and a classification identifier to the server is provided.

### BRIEF DESCRIPTION OF THE DRAWINGS

FIGS. 1A and 1B are block diagrams of a workflow system of the present invention.

FIGS. 2A and 2B are detailed block diagrams of the workflow system of the present invention shown in FIGS. 1A and 1B.

FIGS. 3A and 3B are detailed block level diagrams of the workflow system of the present invention.

FIG. 4 is a block diagram of a workflow system of a present invention in which files are delivered “on-line.”

FIG. 5 is a detailed block diagram of the workflow system of the present invention.

FIG. 6 is a block diagram of a portion of the workflow system of the present invention showing delivery and validation.

FIG. 7 is a block diagram of the workflow system of the present invention showing the connection of the various networks to an internet and their interaction therewith.

FIG. 8 is a screen display showing the tailored classified file deposit screen displayed on a processor in the workflow system of the present invention.

FIG. 9 is a tailored classified file delivery screen showing the display of an image processor in a workflow system of the present invention.

FIGS. 10A-10E are block level diagrams showing the various processes of the workflow system of the present invention.

FIG. 11 is a block diagram of a process flow to determine if a file is to be processed using process Ba or process Bb.

FIG. 12 is a image of a screen to approve or reject a file deposit screen.

FIG. 13 is a block level diagram of a workflow in which a file is received at step A and the same file is transferred in parallel to steps B and C. The possibility of it being rejected at one or more of the nodes is shown.

FIG. 14 is a block level diagram of a work level system in which two files from two different processes are co-joined and are further processed and separated.

### DETAILED DESCRIPTION OF THE INVENTION

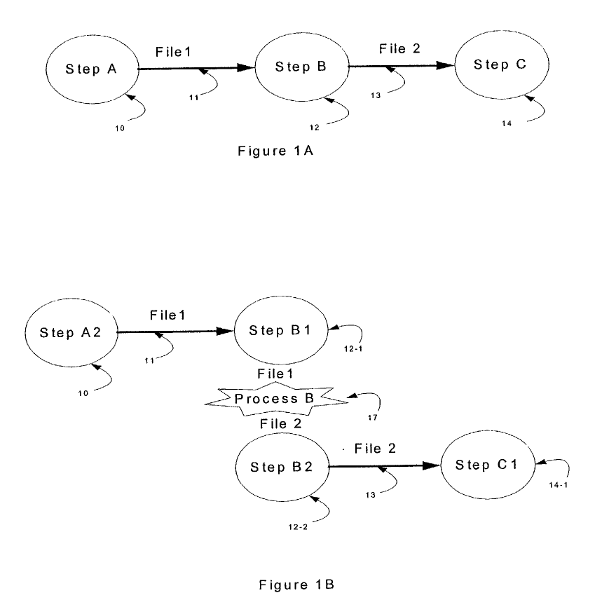

Unlike the prior art, noted above, there is a class of information that is not represented as data in fields in a screen but carried as a packet of data called a file where the contents of the file are in a format and structure useable by a specific program. A file may be quite large, measured in megabytes, and only viewable using a specific program such as a computer aided design system (CAD). An example of a process where the significant data are in a file would be a product design process where an engineer A develops a product using a CAD system that creates a first file as an output. The first file is then given to second engineer B who uses the first file as input to a CAD system to add details to the design and creates a second file. The second file is sent to a third engineer C who uses the second file as input to the CAD system, and so forth. FIG. 1A represents a three-step business process where the engineer A at Step A creates File 1. The engineer B at Step B uses File 1 as input and creates File 2 as an output. The engineer C at Step C uses File 2 as input. Most processes and workflow systems represent the business process in FIG. 1A as this three-step process. However, upon closer analysis, FIG. 1B is a closer representation where there are four steps:

1. Step A2 represents a process step where File 1 is deposited and sent to Step B and

2. Step B1 is the process step where Step B takes delivery of File 1. Step B executes Process B that uses File 1 as input to create File 2 as output.

3. Step B2 represents the process step where File 2 is deposited and sent to Step C and

4. Step C1 represents the process step where Step C takes delivery of File 2.

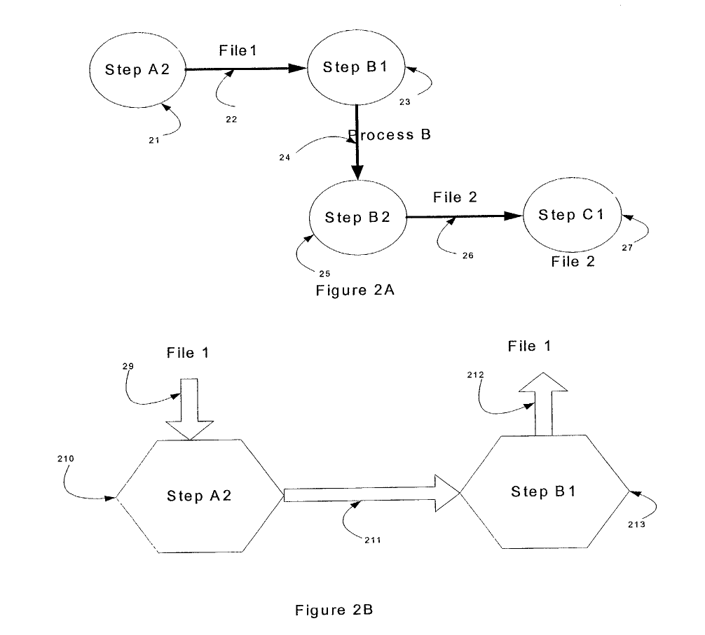

The process steps for Step A to Step B to Step C of FIG. 1A do not account for requirement that a file be delivered for input to an external system, the CAD system in the example, and that a resulting file be deposited for delivery to subsequent process steps. That is, Step B is not a single workflow step where data are displayed in a screen and new data are entered in fields but really two steps where a file is delivered for processing at Step B using screen B1 and then a resulting file is deposited using screen B2. The three step process of FIG. 1A is more accurately represented as the four-step process illustrated in FIG. 2A as Step A2 (file deposit) to Step B1 (file delivery or extraction) to Step B2 (file deposit) to Step C1 (file delivery) where Step A2 to Step B1 transfers File 1; Step B1 to Step B2 represents the execution of Process B with File 1 as input and File 2 as an output; and Step B2 to Step C1 transfers File 2. The process steps in FIG. 2A can be represented as two pairs of nodes where each pair represents the deposit of a file and the delivery of the file as illustrated in FIG. 2B and a file processing activity that connect the delivery to a deposit. A first objective of the invention is a system that more easily supports the process steps of file deposit and delivery so that these may be automated and controlled using workflow systems.

Each file usually has an identifier or file name assigned by a user, a person. An example is the name of the Word document for this patent application. The name was given by the author but may not have much meaning to others who read the file name. In some processes, the file name is assigned in a systematic manner. For example, in a CAD system, the filed associated with the master CAD file have file names that have the master CAD file name as the root of the file name with a suffix assigned by the CAD system designating the function of the particular file. The file name has meaning in the context of the system in which it is used. However, the file name loses much of the functional identity when removed from the original system context. The functional meaning of the CAD system file name suffix only has meaning in the context of the CAD system; the fiel name of the patent application only has meaning in the file system of the patent author. To maintain the functional identification and to associate the files with others needed for a specific business process, additional information, some times called “classification data” or “meta data” is needed to identify the file. As an example, for product descriptive files, classification data may include the part number of the product, the revision level of the product, and the type of file. In addition, the classification data may include the revision level of the file. That is, the file may have been revised several times to support a revision level of the product and each revision level of the file needs to be tracked. Describing each file by the associated classification information permits accurate identification of the file for deposit and delivery. A second objective of the invention is to use the file classification as a means to manage the files in deposit and delivery process.

Many systems to support complex business processes are themselves complex and require extensive training of users and long implementation schedules. The complexity of the system and the continued maintenance creates a situation where many people have to learn new skills and focus on learning the system rather than helping them with their jobs. Because of turnover in the user base due to promotion, vacation, sickness, etc., the organization is constantly training new users on the use of the complex system. A third objective of the invention is to use the workflow controlled deposit and delivery and the file classification to provide tailored user screens that target the use by the user so that the training is simple and intuitive.

Many of the processes that use files as input and create output are run with human assistance, off-line processing, and can be automated, on-line processing. In most instances, the content of the input file is of indeterminate structure and requires human intelligence and judgment before processing or before judgment, by human or program, can be made. A controlled process and standardizing of file content can create the environment where the off-line process can be understood, the input files processed to a standard, and a portion of the off-line process converted to a workflow controlled on-line process. This combination of off-line processes and on-line processes can then be further understood and the portion of off-line processing decreased as more of the function is done as on-line processes. A fourth objective of this invention is to create an environment where off-line processes may evolve to full workflow controlled on-line processes.

In summary, there are four objectives of the present invention:

A first objective of the invention is a system that more easily supports the process steps of file deposit and delivery so that these may be automated and controlled using workflow systems.

A second objective of the invention is to use the file classification as a means to manage the files in deposit and delivery process.

A third objective of the invention is to use the workflow controlled deposit and delivery and the file classification to provide tailored user screens that target the use by the user so that the training is simple and intuitive.

A fourth objective of this invention is to create an environment where off-line processes may evolve to full workflow controlled on-line processes.

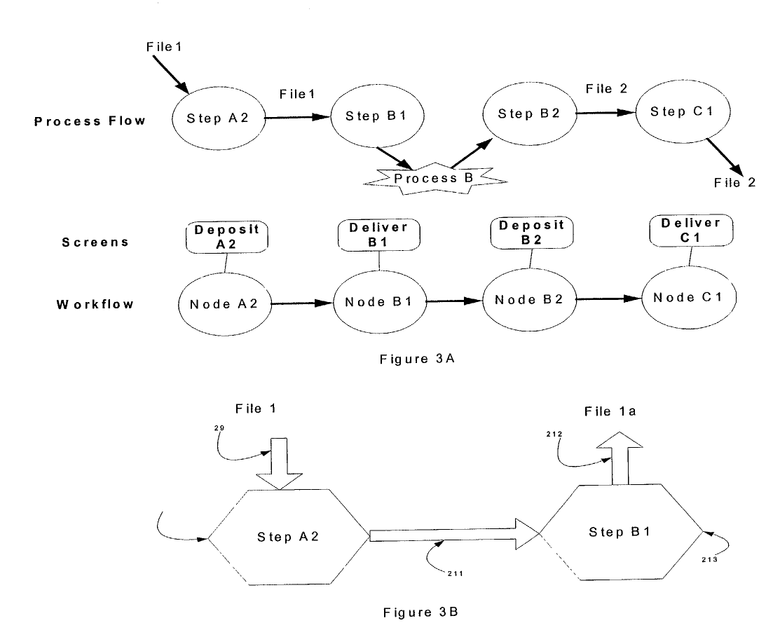

The first objective of the invention is the controlled deposit and delivery of information in the form of data files. A first user A is directed by a first screen to deposit a file that meets a specific description or classification. A second user B is directed by a second screen to take delivery of the described file. The deposit of a file means the transfer of block of data from a storage location on a storage device to the system supporting the deposit screen. The delivery of a file means the transfer of a block of data from the system supporting the screen to a storage location on a storage device. The invention transfers file 1 from process Step A2 to process Step B1 by depositing file 1 into a file server associated with the system supporting the screen by user A at Step A2 and giving access to file 1 on the file server to user B at Step B1 where file 1 can be transferred from the file server and used by user B at Step B1 as input to a process executed by B. Illustrated in FIG. 3 are the relationships between user A, user B; the process steps of deposit, Step A2, and deliver, Step B1; the file server; the workflow and screens. The transfer is initiated by activation of workflow Node A2 that presents a tailored classified file deposit screen requesting user A at Step A2 to deposit a file fitting the description of file 1. The description includes the type or classification of the file. Examples of classifications are: computer aided design system file (CAD), product description file, bill of material file (BoM), Approved Manufacturer List file (AML), etc for a specific product described, for instance, by a name or part number and a revision level. When file 1 is transferred using the deposit screen, the classification is kept in association with file 1. At the completion of the file transfer, the work flow activates node B1 and presents a tailored classified file delivery screen tailored for delivery of a file fitting the description of file 1 to user B at Step B1.

FIG. 3A illustrates a process flow where the deposit of file 1 at Step A2 followed by a delivery at Step B1. At B1, file 1 is used as input to Process B to create file 2 as an output file. File 2 is deposited at Step B2 followed by a delivery at Step C1. FIG. 3B illustrates the workflow and screens presented at each of these process steps. Process flow Step A2 corresponds to Workflow node A2 where screen Deposit A2 requests the user A to deposit of file 1. When file 1 is deposited by the user A using the screen Deposit A2, the workflow activates Node B1 which presents screen Deliver B1 to user B. The user B takes delivery of file 1 and the workflow activates node B2 that presents screen Deposit B2 to user B. User B uses file 1 as input to Process B to create file 2 and uses the Deposit B2 screen to deposit file 2. The workflow activates node C1 that presents Deliver C1 screen to user C. As an example, User B can download CAD and BoM files through screen Deliver B1, merge and process the files involving various off-line standalone programs and create a new file that is ready to be used in a surface mount assembly line. User B will now deposit the surface mount assembly program file using the screen Deposit B2.

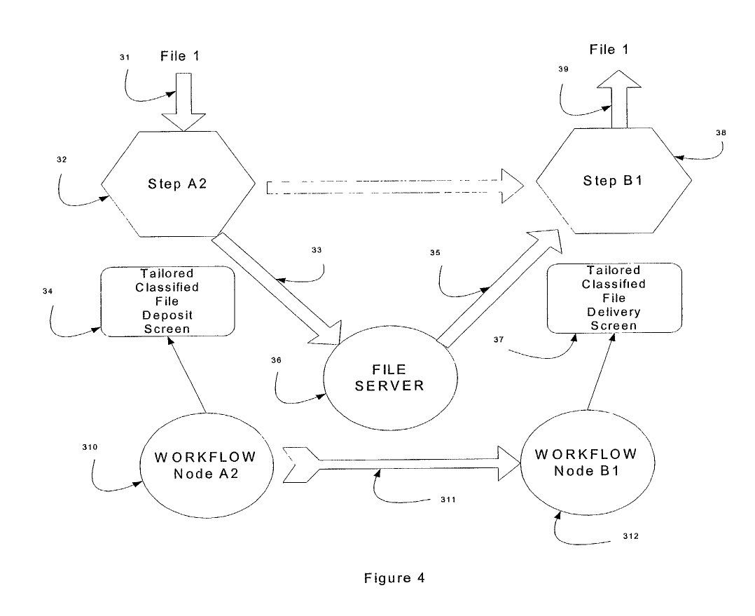

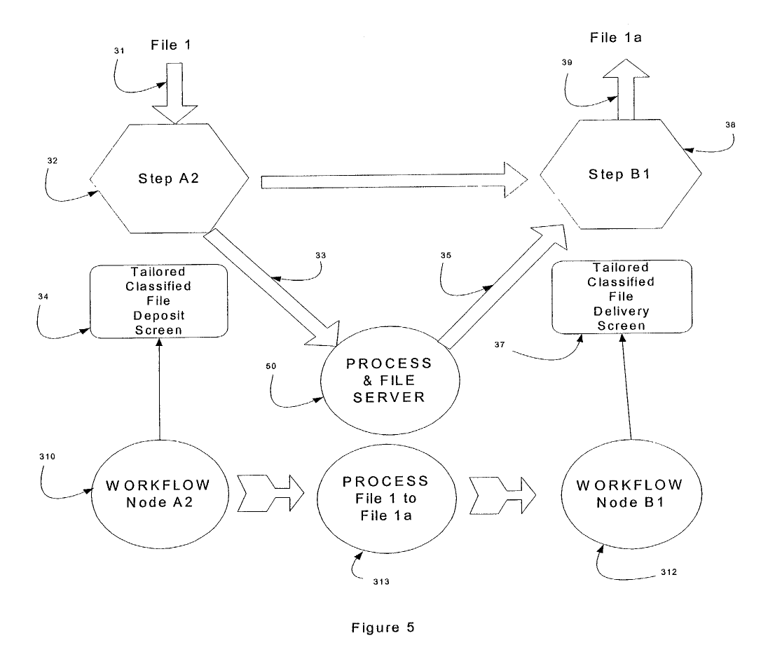

The deposit and delivery model is well suited for business processes where the file processing is done “off-line”, that is by functions at the user's location. A file is delivered, processed off line, and the resulting file is deposited for subsequent processing steps. This is shown in FIG. 4. However, there may be “on-line” processing where a deposited file is processed by server based function and the resulting file delivered. As illustrated in FIG. 5, file 1 is deposited at Step A2, file 1 is processed resulting in file 1a, and file la is delivered at Step B1. As an example, if a CAD and a BoM files are deposited at Step A2, these files will be automatically processed to compare the CAD and the BoM and generate the updated CAD with the master data from the BoM. The resulting CAD file and the original BoM file is now delivered at Step B1. The user at Step B1 is now presented with a CAD file that was processed using an on-line process. The relationship of the users A & B; the process steps to deposit, process, and deliver; the process and file server; the workflow and screens are also shown in FIG. 5. Workflow node A2 activates the tailored classified file deposit screen to user A that requests the transfer of file fitting the description of file 1. When file 1 is transferred to the process and file server using the deposit screen, the workflow activates the process file 1 to file 1a node and the process and file server performs this process resulting in file 1a. At the completion of the file process node, the workflow activates node B1 that presents the tailored classified file delivery screen to user B for transfer to user B.

The tailored classified deposit screen is tailored to request files that match a specific description including the file classification, e.g. CAD, BoM, etc for a specific product with part number and revision level. Each requested file has a deposit function on the screen with the classification. Similarly, the tailored classified delivery screen provides the specific files and matching descriptions for that step in the process. The workflow has for each node, the user identification, and for each file, the file descriptive information and mechanism to deposit the file for the deposit screen or a download mechanism for the delivery screen.

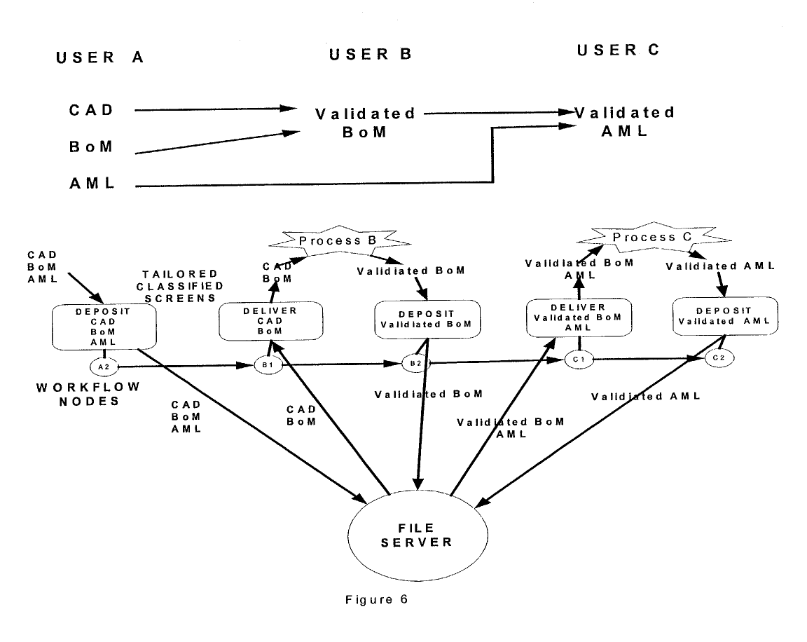

As a business process example, a product is identified by a part number and revision level and has an associated set of files: CAD, BoM, and AML. In the business process, user A gathers the set of files, CAD file, BoM file, and AML file. Then, user B processes the CAD file and BoM file to produce a validated BoM, and then, user C processes the AML file and validated BoM to produce a validated AML. The flow of files is illustrated in FIG. 6.

The tailored classified file deposit screen for user A will display the product part number and request the CAD file, the BoM file, and the AML file. This screen will have three file deposit mechanisms where one is labeled “CAD file”, one labeled “BoM file”, and one labeled “AML file”. The tailored classified delivery screen for user B will display the product part number and deliver the file deposited in the CAD file mechanism as the CAD file and the file deposited in BoM file mechanism as the BoM file. User B extracts the CAD file and BoM file and executes the off-line process, Process B, to generate the validated BoM. The tailored classified deposit screen requests the validated BoM from user B. This screen will display the product part number and have one file deposit mechanism labeled “validated BoM file”. The tailored classified delivery screen for user C will display the product part number and deliver the file deposited in the AML file mechanism as the AML file and the file deposited in the validated BoM file mechanism as the validated BoM file. User C extracts the AML file and validated BoM file and executes the off-line process, Process C, to generate the validated AML. The tailored classified deposit screen for user C will display the product part number and a file deposit mechanism labeled “validated AML”. The tailored classified screens target the use by the user so that the screens are instructive and easy to use.

The file classification is not just limited to the file type but can include the version or revision level of the file or the date or other distinguishing characteristic. In the example above, user A may have submitted the CAD, BoM and AML files at the original version level and later submitted a newer version of BoM. The tailored classified delivery screen for user B can be set to deliver the most recent set of files. It would then deliver the original CAD and AML and the newer version of the BoM.

The invention uses a workflow to control the execution of on-line processes in combination with the deposit and deliver function for off-line processes.

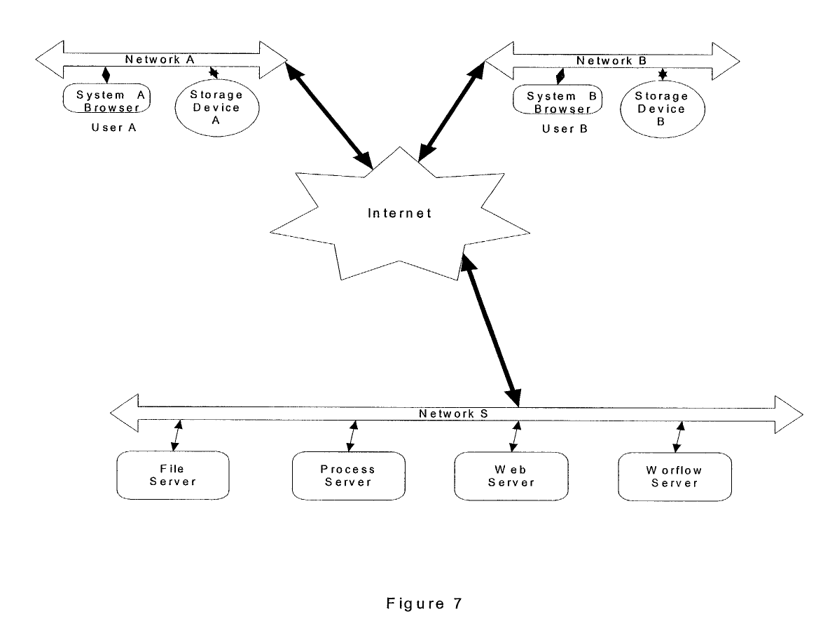

In FIG. 7, user A has a computer A with a web browser program A connected to a network A connected to storage device A where user A with computer A can store and access data files. Similarly, user B has computer B with web browser program B connected to network B connected to storage device B. The computer A and computer B need not be of the same type and can be of a wide variety such as personal computers with Intel or IBM microprocessors running Microsoft Windows 98, ME, NT, 2000, Apple Macintosh OS X, etc.; or a workstation from Sun running Solaris or a workstation from IBM running AIX; or a terminal connected to a mainframe or midrange computer such as the IBM 9000. The web browser program may be Microsoft Internet Explorer or Netscape Navigators or other web browsers. Networks A and B need not be of the same type and may be of a wide variety such as Ethernet, Token Ring, wireless, FDDI, Storage Area Network, etc. with a variety of network operating protocols such as Novell Netware, Microsoft LAN Manager, NT Server, etc. The storage devices A and B need not be of the same type and may be of a wide variety such as disk drives from IBM or Seagate or others and may be attached to internal data bus of computer A or computer B or attached as a shared storage device from EMC or Network Appliances or others. The storage device may be other than disk storage such as optical storage, DVD, CD-ROM, on-line tape libraries, etc.

FIG. 7 also shows a file server, process server, web server, and workflow server connected to Network S. The servers need not be of the same type and can be of a wide variety of computers and operating systems such as those listed for computer A and computer B. The file server provides organized storage of files and can have storage devices such as disk drives or shared storage listed for network storage and use software such as Microsoft Windows NT or 2000, Novell Netware, or other file management software. The process sever provides transaction and batch program scheduling and execution based on workflow and external commands from the web server and other sources. Bea Web Logic or IBM Websphere or iPlanet Application Server or other software may be used as the base for these process functions. Specific programs may need to be written to provide the functions to be described. The programs may be written in a variety of programming languages such as Java, C++, Active X, C, etc. The web server provides the web interface and provides the web pages for the deposit, deliver and decision functions. Microsoft Internet Information Server or Netscape Server or Sun One or others are examples of web server programs that provide this function. The workflow server provides the sequence of process steps or nodes to accomplish a business process. Bea Web Logic Process Integrator or Extricity Workflow or others provide the workflow functions.

Networks A, B, and S are connect to the Internet. While each network operates independently, the connection to the Internet provides a means for specific operations to be accomplished across the combined networks. These are defined as protocols that are standards for transferring information. The File Transfer Protocol, FTP, is an example of a protocol for sending a data file from one computer connected to the Internet to another computer connected to the Internet. A set of protocols is called the World Wide Web or simply “the web” provides the displaying of graphical user interfaces and functions for text and file transfer and is widely implemented using programs called web browsers.

Those skilled in the art recognize that a wide variety of commercial hardware and software products may be used to accomplish the functions to be described. And in addition, hardware or software may be designed to accomplish these functions. For example, a program may be written for a computer with display and keyboard to accomplish the equivalent results of a web browser without the use of a web browser, web server, or file server. In fact, the network need not be the Internet but another connection of computers to provide the capability to deposit and deliver a file using a workflow control. Thus, the networks A, B and S may also be connected through a corporate intranet or a VPN (Virtual Private Network) portion of an internet.

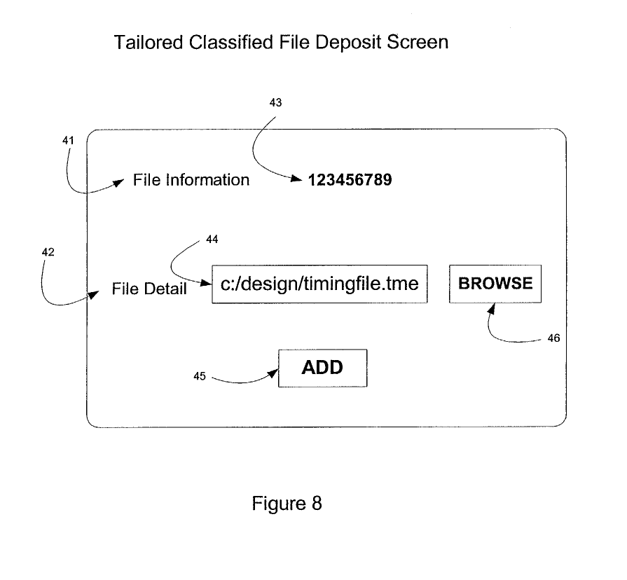

FIG. 8, shows a deposit screen and provides a description of the file to be deposited, a function to locate the file on a storage device, and a function to transfer the file to a file server. The classification of the file is also sent with the file to the file server. The tailored classified file deposit screen is made available to the user at computer A. In the preferred embodiment the screen is a web page provided by the web server where the specific user and web page are defined by a workflow. The web page contains file identification information such as a part number of the data represented in the file and the specific classification of file for that part number. Examples of the classifications of files are CAD, BoM, AML, etc. The “browse” function is activated by the user by “pushing” the BROWSE button. This function opens a window to the directory of files on storage devices attached to network A. The browse function permits user A to select a file on a storage device connected to network A. The ADD function moves the selected file from the storage device connected to network A and the file classification, over the Internet, to the file server connected to network S. This is similar to the function that is used to attach a file to an e-mail and familiar to many and especially those skilled in the art. The specification of the file identification, the file classification, and the user are set in the workflow where the workflow is specified to accomplish a specific business process.

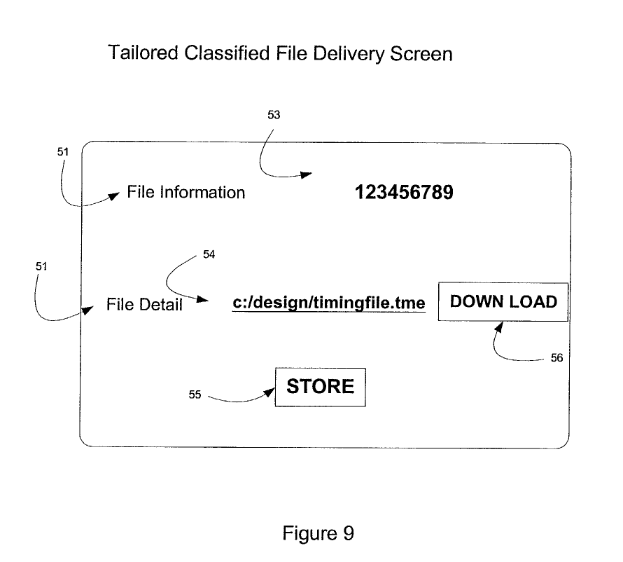

FIG. 9, shows a delivery screen and provides a description of the file to be delivered, function to locate the storage device location as the target for the file deposit, and a function to transfer the file from the file server to the location on the storage device. The tailored classified file delivery screen is made available to the user at computer B. In the preferred embodiment, the screen is a web page provided by a web server where the specific user and web page are defined by a workflow. The web page contains the file identification information such as part number of the data represented in the file and the specific classification of file. The download function is activated by the user by “pushing” the DOWN LOAD button. This function opens a window to the directory of files on storage devices attached to network B. The download function permits user B to select a target location on a storage device connected to network B. The STORE function moves the file from the file server connected to network S, over the Internet, to the storage device connected to network B. This is similar to the function that is used to store a file attached to an e-mail and familiar to many and especially those skilled in the art. The specification of the file identification, the file classification, and the user are set in the workflow where the workflow is specified to accomplish a specific business process.

The deposit and delivery model of FIG. 4 is implemented with a workflow that specifies at node A2 for user A, a Tailored Classified File Deposit screen with the file specification and classification for the deposit of file 1 and specifies at node B1 for user B, a Tailored Classified File Delivery screen with the file specification and classification for the delivery of file 1. When the workflow is activated, the first node is node A2 and the Tailored Classified File Deposit screen is presented to user A. User A uses the specification and classification information to determine the requested file as file 1. User A uses the BROWSE function provided by the screen to locate file 1 on a storage device A connected to network A. User A then uses the ADD function to move file 1 from the storage device A through the Internet to the file server connected to Network S. The workflow then moves to the next node, node B1 where the Tailored Classified File Delivery screen is presented to user B. User B uses the specification and classification information to determine the delivered file as file 1. User B then uses the DOWNLOAD function to determine the desired location on storage device B connected to Network B. User B then uses the SAVE function to move file 1 from the file server connected to Network S through the Internet to the specified location on storage device B.

In a similar manner, the deposit, process, and delivery model of FIG. 5 is implemented with a workflow that specifies at node A2 for user A, a Tailored Classified File Deposit screen with the file specification and classification for the deposit of file 1, a process that takes file 1 as input and generates file 1a as output, and specifies at node B1 for user B, a Tailored Classified File Delivery screen with the file specification and classification for the delivery of file 1a. When the workflow is activated, the first node is node A2 and the Tailored Classified File Deposit screen is presented to user A. User A uses the specification and classification information to determine the requested file as file 1. User A uses the BROWSE function provided by the screen to locate file 1 on a storage device A connected to network A. User A then uses the ADD function to move file 1 from the storage device A through the Internet to the file server connected to Network S. The workflow then moves to the next node, where the process server activates a process that uses file 1 from the file server as input to generate file la as output and stores it on the file server. The workflow then moves to the next node, node B1 where the Tailored Classified File Delivery screen is presented to user B. User B uses the specification and classification information to determine the delivered file as file 1a. User B then uses the DOWNLOAD function to determine the desired location on storage device B connected to Network B. User B then uses the SAVE function to move file 1a from the file server connected to Network S through the Internet to the specified location on storage device B.

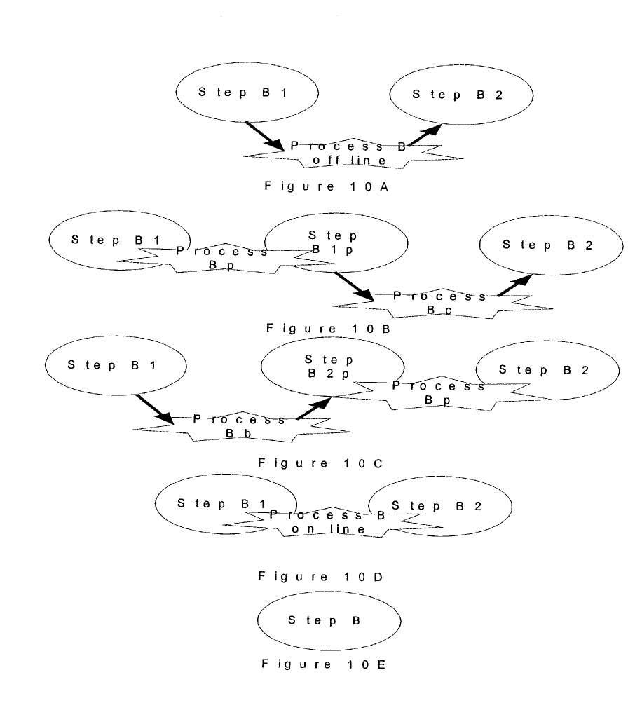

The on-line and off-line processing evolution is illustrated in FIGS. 10A to 10E. In FIG. 10A, the deposit and deliver model may be used to deliver a file at Step B1 to user B that is then used as input to Process B. Process B is not controlled by the workflow system so is an off-line process. The file that is generated as output from Process B may be then deposited at Step B2 for delivery and further processing using the workflow. Process B may be divided into two parts: an on-line portion, Process Bp, and an off-line portion, Process Bc. The deposit, process, deliver model may be used as illustrated in FIG. 10B where Step B1 invokes Process Bp where the output file is delivered by the deliver screen at Step B1p. User B takes delivery of the file and runs the off-line Process Bc and uses the deposit screen of Step B2 to transmit the file to the subsequent workflow steps. An example application of this model is where an automated process prepares a file in a standard way so that the file is formatted to load easily into the off-line process, such as the automated formatting of a file so that it can be loaded and processed by a spread sheet program, for example Microsoft Excel.

Or as illustrated in FIG. 10C, where Step B1 delivers the file to user B runs the off-line process Bb and uses the deposit screen B2p to deposit the output file. The workflow invokes the on-line Process Bp and delivers the resultant file to Step B2. An example application of this model is where the file delivered at Step B1 has wide variability and an off-line process and human judgment is used to create a standardized file for input to the on-line process Bp such as Bill of material that may have data fields with descriptors that may be read by a person. It may be difficult to write a program to assure that all descriptors are accurate, but it may be possible to write a program that checks the accuracy of most descriptors and provide an easy to use interface for a persona to manually validate the remaining descriptors. The resultant validated file then can be formatted into a standardized format for automated processing of the subsequent steps.

These models may be used to evolve off-line process to on-line processes where the initial process is all off-line and use the deposit and deliver model. As the off-line process becomes better understood, the process is divided into an on-line process and an off-line process. As the process understanding increases, the division between on-line and off-line becomes more toward the on-line process. The limiting point is illustrated in FIG. 10D where the entire process is on-line and controlled by the workflow and can be represented as a single node as shown in FIG. 10E. as an example of off-line process evolving to an on-line process, consider the process of formatting of a sequence of Bills of Material, BoMs, into a standard format where the BoMs are in a new but consistent format. Since the format is new, the first BoM is processed off-line by a person. After processing the first BoM, features of the BoM are observed and an on-line program is written to reformat the BoM into the standard format but also check that the input format is consistent with those features observed in the first BoM. If a subsequent BoM is not consistent with the features of the first BoM, then the program creates an off-line fiel and BoM is processed off-line by a person. The features of the BoMs that are processed off-line can be observed and the on-line program can be augmented to accommodate these features so that more BoMs are processed on-line. The limit point is when the on-line program has been augmented so that it processed all BoMs.

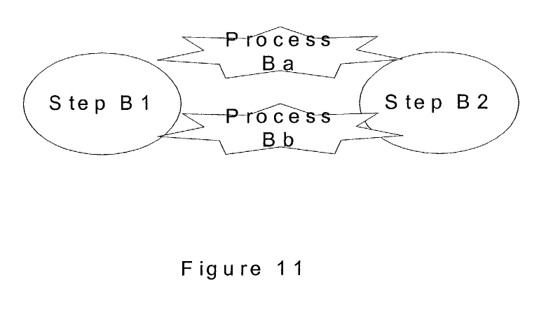

Careful examination of FIGS. 10B and 10C will show that both are illustrations of the same concept when viewed in a more extensive workflow where the on-line process can always be re-labeled to be part of the input to the off-line process. That is, FIG. 10C can be re-labeled where Step B2p and Step B2 become Step B2 and C1p respectively and the on-line process is view as an input process to Step C. Thus the on-line and off line processing of FIG. 10C has the same topology as FIG. 10B except moved to the next set of nodes labeled C. This discussion is to state that given two nodes with processing between them, the processing can be viewed as post processing from the view of the first node or pre-processing from the view of the second node. The classification of a file is used to determine the screen in which it is to be delivered. The file classification can also be used to select the on-line process. As illustrated in FIG. 11, the classification of a file at Step B1 I used to determine if the file is to be processed using Process Ba or Process Bb. As an example, if the files were classified as Bill of Material, the on-line Bill of Material processing program would be executed. If the file were classified as a CAD file, the on-line CAD process program would be executed.

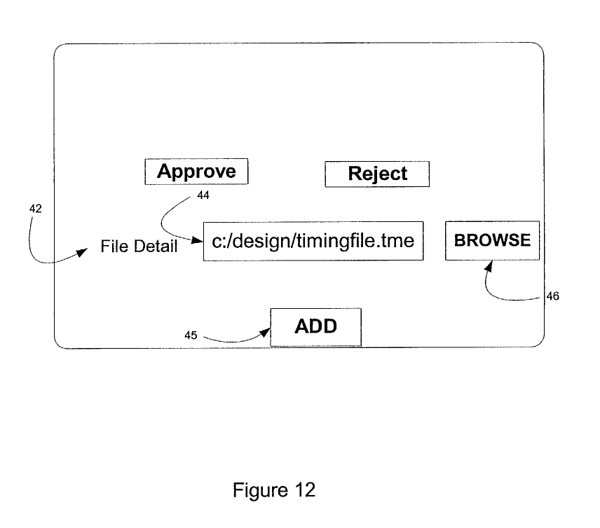

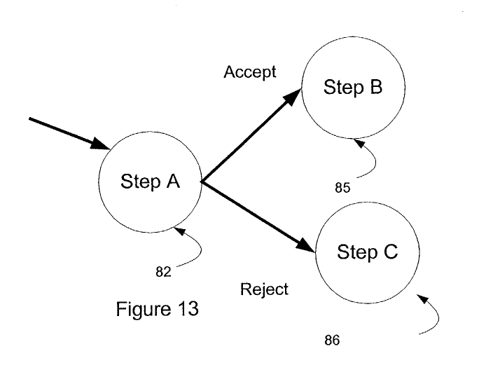

The file classification can be used to group the file for further processing. For example, a formatted Bill of Material would be classified differently from the original Bill of Material. The file classification can separate the processed files from the original files. That is, the classification can reflect the state of the file as it is processed. The workflow process must have the ability to reflect the action of decisions and external factors. Most workflow systems provide a conditional branch capability where a user or a programmed condition can select one of several successor nodes as the next node to execute. The conditional branch is used for an approval or reject decision where if approved, the process flows to one workflow branch and if rejected, the process flows to another workflow branch. FIG. 12 illustrates an approve or reject screen. The screen also illustrates a file deposit mechanism so that a classified file may be sent with the decision. A process that determines the classification of a file and selects a workflow branch can decide the conditional branch condition. Or the content of a file or even the existence of a file can be use to determine the conditional branch condition. For example, a workflow may have a branch to process a Bill of Material. This branch may be executed only if there is a Bill of Material in the set of files to be processed. Thus, the file classification can be used to automate the selection of the workflow process. FIG. 13 illustrates the workflow nodes of a conditional branch at Step A where Step B is executed if the decision at Step A is “accept” or Step C is executed if the decision is “reject”.

Many processes require parallel processes. For example, the Bill of Material may be processed by the procurement engineer and also by the manufacturing engineer. The procurement engineer process is different from the manufacturing engineering process so that they cannot execute the same process. In most situations, these processes may be executed in parallel and the overall process continues when both have completed their parallel segment (an “and” join). The workflow terminology for the split of the overall process into parallel segments is a “fork” and the joining of the segments as a “join”. These terms come from the long standing computer science lexicon of parallel processing.

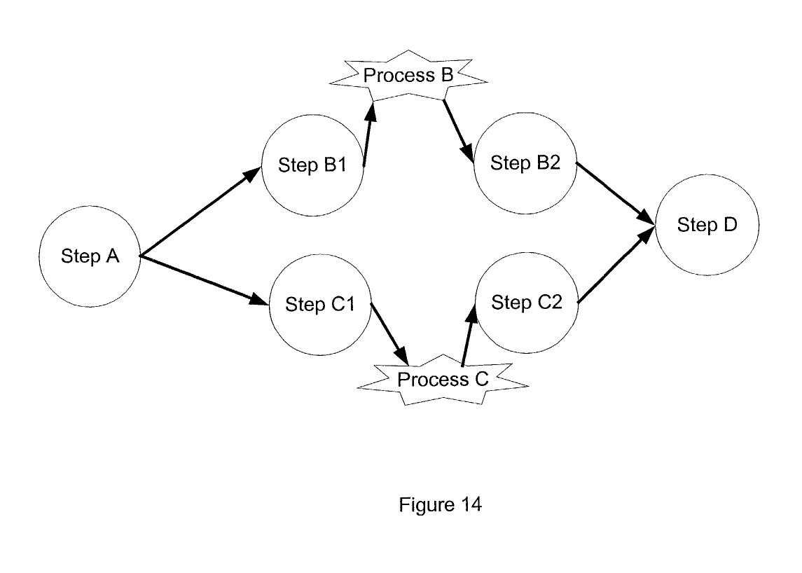

FIG. 14 illustrates parallel workflow segments where the overall workflow starts at Step A, one parallel segment consists fo the delivery of a file at Step B1, Process B, and deposit of the resultant file at Step B2 and the second parallel segment consists of the delivery of a file at Step C1, Process C, and deposit of the resultant file at Step C2, and the overall workflow continuing at Step D. As with parallel processing, the fork may be conditional , that is parallel segment may begin based on meeting a set of conditions or the join may be an “or” where the completion of one segment will permit the continued execution of the overall process (in contrast to the “and” join where both segments must complete). Those skille din the art and familiar with workflow controlled processes can envision the mapping of a workflow network of nodes to control a defined process. The tailored classified deposit screens and delivery screens can be mapped onto the process and controlled by the workflow.

In summary, in the present invention, the tailored screen permits the screen to match the business process requirements for that specific process step: the product descriptions and the number of files each with their classification. The classification of the file allows controlled delivery of the file to match the business requirements. A file deposited at a node need not be delivered at the next node but at the node that matches the business process requirements. The workflow with tailored classified deposit screens and tailored classified delivery screens supports complex processes where the data are carried as files. The tailored and classified nature of the screens permits easy understanding and use by the users and minimizes the training of users.

The invention recognizes that for off-line processes that use files as the information unit require the workflow system to provide a first screen to deliver a file to a user and a second screen to request from the user the deposit of the file as a result of an off-line process step. In addition, the invention recognizes that the file is not entered into a data field but must be transferred from a storage location on a storage device for deposit and transferred to a storage location on a storage device for delivery.

The invention uses a workflow to control the sequence of nodes, the address of the user for each node and the tailored classification screen for each node.

The invention uses the workflow, the classification of the files, and the tailored classification screens to match the business process requirements so that the tailored classified screens are targeted to the user roles and easy for the users to understand and learn to use.

The invention supports the controlled deposit and delivery of information in the form of data files. The control is provided by user a screen that direct the deposit of specified file, a user screen that directs the delivery of a specified file, and a workflow system adapted to direct the screens to specific users in the appropriate sequence and with appropriate file specifications to accomplish a defined process. The deposit of file transfers the file from a storage device controlled by the user to an intermediate storage device associated with the screen server. The delivery of a file transfers the file from the intermediate storage device to a storage device controlled by the user.

What is claimed is:

1. A tailored classified file deposit screen provided by a server connected to a first computer network wherein the tailored classified file deposit screen is configured to transfer a specific classified file, based on a step in a sequence of steps of a process, providing the following:
a display of a specification of the file;
means to identify the file on a storage device connected to a second computer network; and
means to transfer the file and a classification identifier to the server.

2. The tailored classified file deposit screen of claim 1, wherein the tailored classified file deposit screen is a web page presented by a web browser and the server is a web server connected to the Internet, an intranet, or an extranet.

3. The tailored classified file deposit screen of claim 1, wherein each step of the process is a node in a sequence of nodes of a workflow describing the process.

4. The tailored classified file deposit screen of claim 3, wherein the workflow is implemented using a workflow system and the file specification and classification are determined based on the node in the workflow represented in the workflow system.

5. The tailored classified file deposit screen of claim 1, wherein the screen or server validates the file that was transferred matches the classification.

6. The tailored classified file deposit screen of claim 5, wherein the screen or the server returns a message to the user based on the validation.

7. A tailored classified file delivery screen provided by a server connected to a first computer network wherein the tailored classified file delivery screen is configured to transfer a specific classified file, based on a step in a sequence of steps of a process, providing the following:
a display of the specification of the file;
means to determine the file storage identification on a storage device connected to a third computer network; and
means to transfer the file from the server to the storage device.

8. The tailored classified file delivery screen of claim 7, wherein the tailored classified file delivery screen is a web page presented by a web browser and the server is a web server connected to the Internet, an intranet, or an extranet.

9. The tailored classified file delivery screen of claim 7, wherein each step of the process is a node in a sequence of nodes of a workflow describing the process.

10. The tailored classified file delivery screen of claim 9, wherein the workflow is implemented using a workflow system and the specific classified file and file specification are determined based on the node in the workflow represented in the workflow system.

11. The tailored classified file delivery screen of claim 7, wherein the server transfers the classification of the file.

12. An information logistics system comprised of a tailored classified deposit screen and a tailored classified delivery screen both provided by a server connected to a first computer network wherein the information logistics system implements an information deposit and delivery process consisting of a deposit process step to deposit a specific file followed by a delivery process step to deliver the specific file where the tailored classified deposit screen is used to transfer a specified file from a first storage device connected to a second computer network to the server and the tailored classified delivery screen is used to transfer the file from the server to a second storage device connected to a third computer network.

13. The information logistics system of claim 12, wherein the tailored classified deposit screen and tailored classified delivery screen are web pages displayed by a web browser and the server is a web server connected to the Internet, an intranet, or extranet.

14. The information logistics system of claim 12, wherein each step of the process is a node in a sequence of nodes of a workflow describing the information deposit and delivery process.

15. The information logistics system of claim 12, wherein the workflow is implemented using a workflow system and the file specification is determined based on the node in the workflow represented in the workflow system.

16. A classified file separator that divides a set of classified files into a first classified file set and a second classified file set based on a classification characteristic of each file.

17. An information logistics and processing system comprised of a tailored classified deposit screen and a tailored classified delivery screen both provided by a server connected to a first computer network wherein the information logistics and processing system implements an information deposit, processing and delivery process consisting of a deposit process step to deposit a first specific file followed by a file process step that uses the first specific file as input to a process to create a second specific file followed by a delivery process step to deliver the second specific file where the tailored classified deposit screen is used to transfer the first specified file from a first storage device connected to a second computer network to the server, the server processes the first specified file to create the second specified file, and the tailored classified delivery screen is used to transfer the second specific file from the server to a second storage device connected to a third computer network.

18. The information logistics and processing system of claim 17, wherein the tailored classified deposit screen and tailored classified delivery screen are web pages displayed by a web browser and the server is a web server connected to the Internet, an intranet, or extranet.

19. The information logistics and processing system of claim 17, wherein each step of the process is a node in a sequence of nodes of a workflow describing the information deposit and delivery process.

20. The information logistics and processing system of claim 17, wherein the workflow is implemented using a workflow system and the file specifications and classifications are determined based on the node in the workflow represented in the workflow system.

21. The information logistics and processing system of claim 17, wherein the file processing step is selected from two file processing processes based on the classification of the specified file.

22. The information logistics and processing system of claim 17, wherein the file process step has two successor delivery process steps and the access to the specified file is passed to both successor delivery process steps.

23. The information logistics and processing system of claim 17, wherein the file process step has two successor delivery process steps and the access to the second specified file is passed to one successor delivery process step based on the classification of the second specified file.

24. The information logistics and processing system of claim 17, wherein the file process step has two successor delivery process steps and the server provides a decision input screen and the access to the second specified file is passed to one successor delivery process step based on the response from the decision input screen.

25. The information logistics system of claim 12, wherein the process step has two successor process steps and the access to the specified file is passed to one successor process step based on the classification of the specified file.

26. The information logistics system of claim 12, wherein a process step has two successor process steps and the server provides a decision input screen and the access to the specified file is passed to one successor delivery process step based on the response from the input screen.

27. The information logistics system of claim 12, wherein the process step has two successor process steps and the access to the specified file is passed to both successor process steps.

28. An information logistics and off-line processing system comprised of a tailored classified delivery screen and a tailored classified deposit screen both provided by a server connected to a first computer network wherein the information logistics and off-line processing system implements an information delivery, file processing, and deposit process consisting of a process step to deliver a first specific file followed by an off-line process step to process the first specified file to a second specific file followed by a deposit process step of the second specific file where the tailored classified delivery screen is used to transfer the first specific file from the server to a first storage device connected to a second computer network, the off-line processing of the first specified file to create a second specific file on a second storage device on a third network and the tailored classified deposit screen is used to transfer the second specific file from the second storage device connected to the third computer network to the server.

29. The information logistics and off-line processing system of claim 28, wherein the tailored classified deposit screen and tailored classified delivery screen are web pages displayed by a web browser and the server is a web server connected to the Internet, an intranet, or extranet.

30. The information logistics and off-line processing system of claim 28, wherein the process steps are nodes in a sequence of nodes of a workflow describing the information deposit and delivery process.

31. The information logistics and off-line processing system of claim 28, wherein the workflow is implemented using a workflow system and the file specifications are determined based on the node in the workflow represented in the workflow system.

32. The information logistics and off-line processing system of claim 28, wherein the off-line file processing step is selected from two file processing processes based on the classification of the specified file.

33. The information logistics and off-line processing system of claim 28, wherein the deposit process step has two successor delivery process steps and the access to the specified file is passed to both successor delivery process steps.

34. The information logistics and off-line processing system of claim 28, wherein the deposit process step has two successor delivery process steps and the access to the second specified file is passed to one successor delivery process step based on the classification of the second specified file.

35. The information logistics and off-line processing system of claim 28, wherein the deposit process step has two successor delivery process steps and the server provides a decision input screen and the access to the second specified file is passed to one successor delivery process step based on the response from the decision input screen.

36. An information logistics on-line and off-line processing system comprised of a tailored classified delivery screen and a tailored classified deposit screen both provided by a server connected to a first computer network wherein the information logistics on-line and off-line processing system implements an on-line file processing, information delivery, off-line file processing, and deposit process consisting of a process step to process a first specific file to second specific file, deliver the second specific file followed by an off-line process step to process the second specified file to a third specific file followed by a deposit process step of the third specific file where the tailored classified delivery screen is used to transfer the second specific file from the server to a first storage device connected to a second computer network, the off-line processing of the second specified file to create a third specific file on a second storage device on a third network and the tailored classified deposit screen is used to transfer the third specific file from the second storage device connected to the third computer network to the server.

37. The information logistics on-line and off-line processing system of claim 36, wherein the tailored classified deposit screen and tailored classified delivery screen are web pages displayed by a web browser and the server is a web server connected to the Internet, an intranet, or extranet.

38. The information logistics on-line and off-line processing system of claim 36, wherein the process steps are nodes in a sequence of nodes of a workflow describing the information deposit and delivery process.

39. The information logistics on-line and off-line processing system of claim 36, wherein the workflow is implemented using a workflow system and the file specifications are determined based on the node in the workflow represented in the workflow system.

40. The information logistics on-line and off-line processing system of claim 36, wherein the on-line file processing step is selected from two file processing processes based on the classification of the specified file.

41. The information logistics on-line and off-line processing system of claim 36, wherein the off-line file processing step is selected from two file processing processes based on the classification of the specified file

42. The information logistics on-line and off-line processing system of claim 36, wherein the deposit process step has two successor delivery process steps and the access to the specified file is passed to both successor delivery process steps.

43. The information logistics on-line and off-line processing system of claim 36, wherein the deposit process step has two successor delivery process steps and the access to the specified file is passed to one successor delivery process step based on the classification of the specified file.

44. The information logistics on-line and off-line processing system of claim 36, wherein the deposit process step has two successor delivery process steps and the access to the specified file is passed to one successor delivery process step based on a characteristic of the second specified file.

45. The information logistics on-line and off-line processing system of claim 36, wherein the deposit process step has two successor delivery process steps and the server provides a decision input screen and the access to the second specified file is passed to one successor delivery process step based on the response from the decision input screen.

46. An information aggregation system comprised of first tailored classified deposit screen, a second tailored classified deposit screen, and a tailored classified delivery screen all provided by a server connected to a first computer network wherein the information aggregation system implements an information deposit, aggregation, and delivery process consisting of a first deposit process step to deposit a first specific file, a second deposit process step to deposit a second specific file, followed by a delivery process step to deliver the first specific file and second specific file where the first tailored classified deposit screen is used to transfer the first specified file from a first storage device connected to a second computer network to the server, the second tailored classified deposit screen is used to transfer the second specified file from a second storage device connected to a third computer network to the server and the tailored classified delivery screen is used to transfer the first file and second file from the server to a third storage device connected to a fourth computer network

47. An information processing system comprising:
a first computer network having a first storage device;
a first monitor;
a second monitor;
a first computer capable of executing a first program adapted to display a screen on said first monitor, to transfer a specific classified file from said first storage device to a predetermined computer; and
a predetermined computer capable of executing a second program, adapted to display a screen on said second monitor the delivery of said specific classified file as input for processing by said predetermined computer.

48. The information processing system of claim 47 wherein said predetermined computer is attached to a second computer network.

49. The information processing system of claim 48 wherein said second computer network further comprising:
a second storage device.

50. The information processing system of claim 49 wherein said predetermined computer is adapted to store said specific classified file on said second storage device prior to processing.

51. An article of manufacture comprising:
a computer usable medium having a computer readable program code embodied therein configured to cause a computer to display on a monitor to transfer a specific classified file from a storage device;
computer readable program code configured to cause said specific classified file to deliver said specific classified file to a predetermined computer; and
compute readable program code configured to cause said predetermined computer to process said specific classified file as input therefor.

52. The article of manufacture of claim 51 wherein said computer usable medium further having a computer readable program code configured to cause said predetermined computer to validate said specific classified file delivered as having a pre-specified classification.

53. A computer data signal embodied in a carrier wave and encoding a plurality of sequences of instructions which, when executed by one or more processors, cause said one or more processors to:
provide a classified file deposit screen by a server connected to a first computer network, wherein the tailored classified file deposit screen is configured to transfer a specific classified file, based on a step in a sequence of steps of a process;
display a specification of the file;
identify the file on a storage device connected to a second computer network; and
transfer the file and a classification identifier to the server.
